(19) United States
(12) Patent Application Publication
(10) Pub. No.: US 2005/0161115 A1
(43) Pub. Date: Jul. 28, 2005

(54) Lumber positioning device on a carpentry cutting bench

(76) Inventor: Yin-Hu Huang, Feng-Yuan City (TW)

Correspondence Address: YIN-HU HUANG, P.O. Box 697, Feng-Yuan City,, Taichung Hsien, 420, TW

(21) Appl. No.: 10/761,255

(22) Filed: Jan. 22, 2004

(51) Int. Cl. B27C 5/00; B27C 1/12; B27C 5/02; B27B 31/00

(52) U.S. Cl. 144/253.1

(57) ABSTRACT

An improved lumber positioning device on a carpentry cutting bench includes a rectangular board secured on the bench, a pair rip fences secured to the lateral edges of the board which has a number of oblique cutting grooves radically formed in center with pair of parallel transverse guide grooves beside the cutting grooves. The rip fences each has a number of corresponding oblique vertical slot communicating the cutting grooves, a pair of positioning plates slidably secured to a protrudent bar in the guide grooves each of which has a rack on an inner wall engageable with the serrated outer edge of a pair of expanding plates inside the positioning plates. A pair of positioning rods each has an elliptic eccentrically integrated at lower end engaged into the positioning plate for rotatably operated the expanding plates to lock or unlock the positioning plates to achieve a non-step gripping a cutting lumber on the rectangular board.

### BACKGROUND OF THE INVENTION

The present invention relates to lumber cutting and more particularly to an improved lumber positioning device on a carpentry cutting bench which is a convenient and accurate non-step lumber positioning type device.

Prior art lumber cutting bench has a plurality of rows of positioning holes in a pinched board on the bottom and a pair of positioning rods spacedly pressed into a pair of selected positioning holes. These positioning rods is used in cooperation with a rip fence to clip the lumber for cutting. However, this type of lumber positioning device uses a pair of positioning rods insert into a pair of immovable positioning holes that could not adjust the space in between so as difficult to correspond with the sizes of the cutting lumber for a tightly gripping. Further, to select a pair of positioning holes to engage within the pair of positioning rods by measuring the distance with the eyes is not accurate. The carpenter must try again and again to find out a pair of exact positioning holes to dispose the pair of the positioning rods to succeed the gripping of a piece of lumber. This is a great disadvantage of the prior is lumber cutting bench.

### SUMMARY OF THE PRESENT INVENTION

The present invention has a main object to provide an improved lumber positioning device on a carpentry cutting bench which adopts non-step positioning structure for quickly and accurately gripping different sized lumbers for cutting that is convenient to a carpenter.

Accordingly, the improved lumber positioning device of the present invention comprises generally a pair of rip fences respectively secured to the lateral sides of a rectangular table. The rip fence each has a plurality of vertical slots of different oblique angles and corresponds with each other. The table has a plurality of meter gauge slots in center surface matched with those vertical slots, at least a pair of straight guide grooves parallel formed beside the meter gauge slots and each having a rack on inner side for engaging with a pair of positioning plates each of which has a central hole for respectively disposing a pair of positioning rods and a horizontal through holes, a pair of arcuate expanding pieces respectively engaged within two end of the horizontal through hole having teeth on their outer peripheries. The arcuate expanding pieces are restrained by at least an elastic ring. The positioning rods each has a handle on the top and an elliptic protrusion eccentrically integrated at lower end and pressed into the positioning plates and the expanding pieces. When rotates the positioning rods for a certain angle, the expanding pieces move outward and their teeth engage with the rack of the straight guide grooves such that the positioning rods together with the rip fences clip a cutting lumber non-steppedly.

The present invention will become more fully understood by reference to the following detailed description thereof when read in conjunction with the attached drawings.

### BRIEF DESCRIPTION OF THE DRAWINGS

FIG. 1 is an exploded perspective view of the preferred embodiment of the lumber positioning device of the present invention,

FIG. 2 is a sectional view looking at one side of the present invention,

FIG. 3 is a vertical sectional view of the positioning plate,

FIG. 4 is a horizontal section view of the positioning plate,

FIG. 5 is a plane view looking from the top of the present invention,

FIG. 6 is a vertical sectional view to a positioning rod disposed into a positioning plate,

FIG. 7 is a horizontal sectional view of FIG. 6,

FIG. 8 is a top plane view of the positioning rod,

FIG. 9 is a sectional view a lumber disposed between a positioning plate and a rip fence,

FIG. 10 is a top sectional view to show that a positioning rod in a positioning plate before rotation,

FIG. 11 is a to sectional view to show that the positioning rod is rotated,

FIG. 12 is an elevational view to show a lumber that is already dipped by the positioning rod and rip fence, and

FIG. 13 is a perspective view to show that a lumber is cutting by a hacksaw.

### DETAILED DESCRIPTION OF THE PREFERRED EMBODIMENT

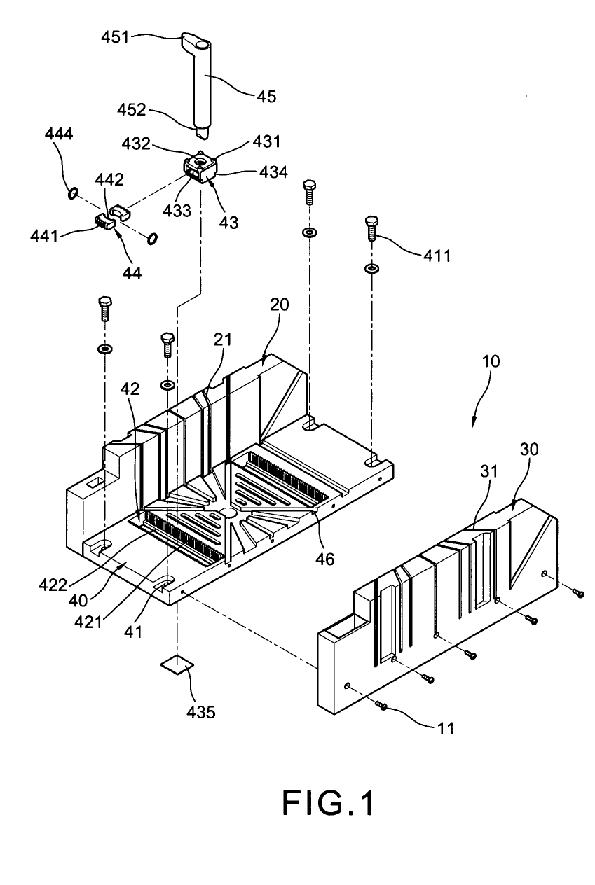

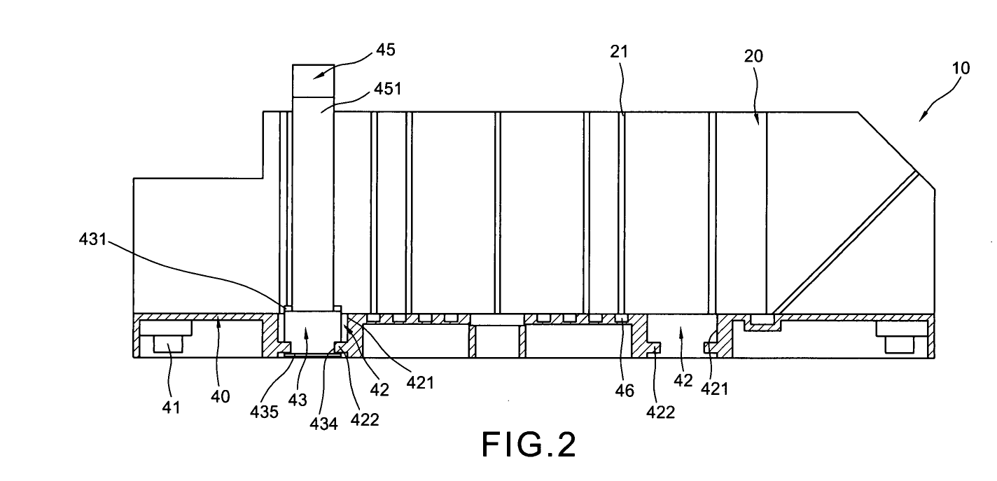

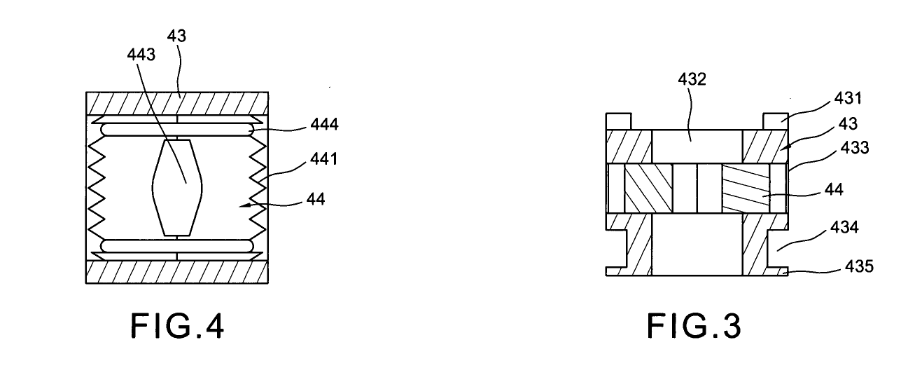

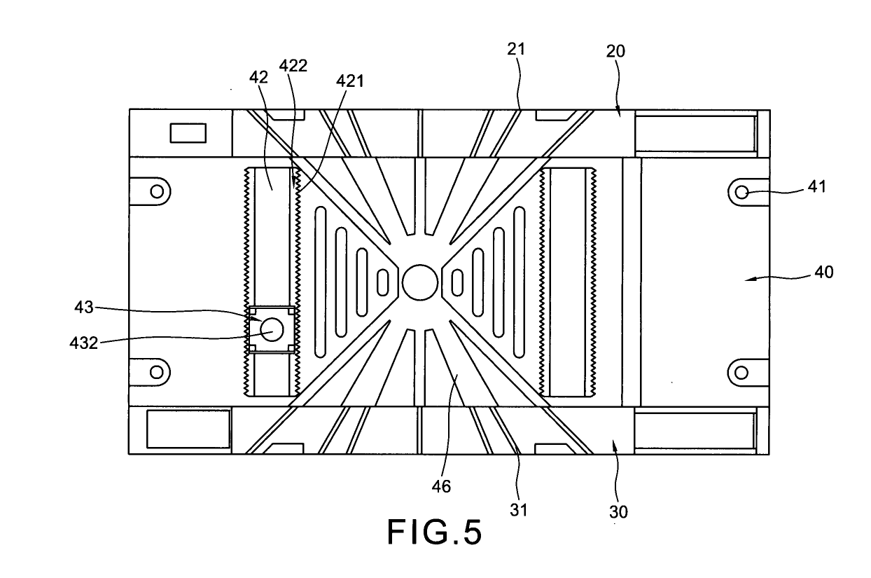

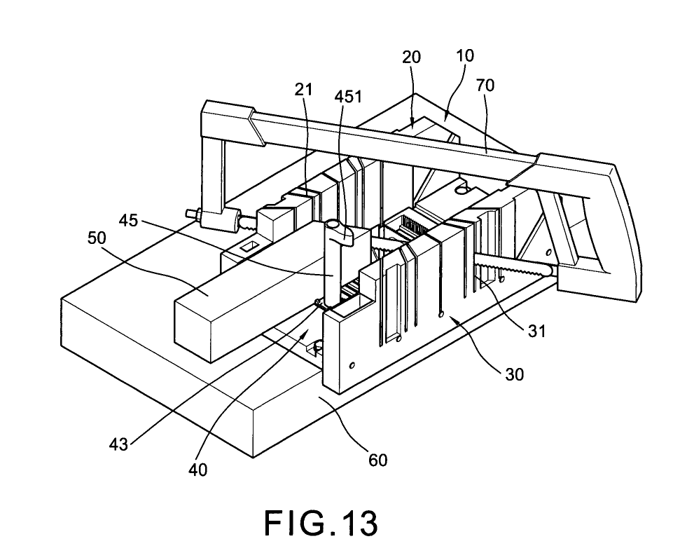

With reference to FIGS. 1 to 5 of the drawings, the improved lumber positioning device 10 of the present invention comprises a pair of symmetrical rip fences 20 and 30 respectively secured to opposing lateral edge of a rectangular board 40 by a plurality of screws 11, wherein the rip fence 20 is positioned uniform with the bottom of the rectangular board 40 and the rip fence 30 is positioned slightly lower than the bottom of the board 40 so that the lower edge of the rip fence 30 may lean on an edge of a working table 60 or engage with a longitudinal groove of the working table 60 (as shown in FIG. 13). The rip fences 20 and 30 each has a plurality of oblique vertical slots 21 and 31 of different angles corresponding with one another. The board 40 has four through holes 41 in horseshoe shaped grooves for securing the lumber positioning device 10 on the working table 60 of a cutting bench by screws 411, a pair of parallel transverse guide grooves 42 and several oblique cutting grooves 46 in the central surface respectively communicating with the oblique vertical slot 21 and 31. The transverse guide grooves 42 each has rack 421 on an inner wall and a protrudent bar 422 on the bottom for slidably disposing a positioning plate 43 each of which has four projections 431 on four corners of the upper surface, a vertical through hole 432 in the center, a pair of horizontal recesses 433 in the opposing lateral sides and a pair of indentations 434 in the opposing edges of the bottom slidably engaged with the protrudent bar 422. A pair of symmetrical expanding plates 44 respectively disposes into the pair of horizontal recesses 433 of the positioning plate 43, each has teeth on outer edge engageable with the rack 421 of the guide grooves 42, a semi-circular inner edge 442 which may be combined into a circular hole after bound up by a pair of elastic rings 444 which provide the resilience force to the expanding plates 44. A rectangular plate 435 disposes under the protrudent bar 422 and connected with the bottom of the positioning plate 43 for preventing the positioning plate 43 from disengaged with the protrudent bar 422. A positioning rod 45 for each of the positioning plate 43 and each has a lateral handle 451 on the top and an elliptic protrusion 452 having an oblique distal position eccentrically integrated with the lower end inserted into the central hole 432 of the positioning plate 43 and the arcuate inner edges 442 of the expanding plates 44.

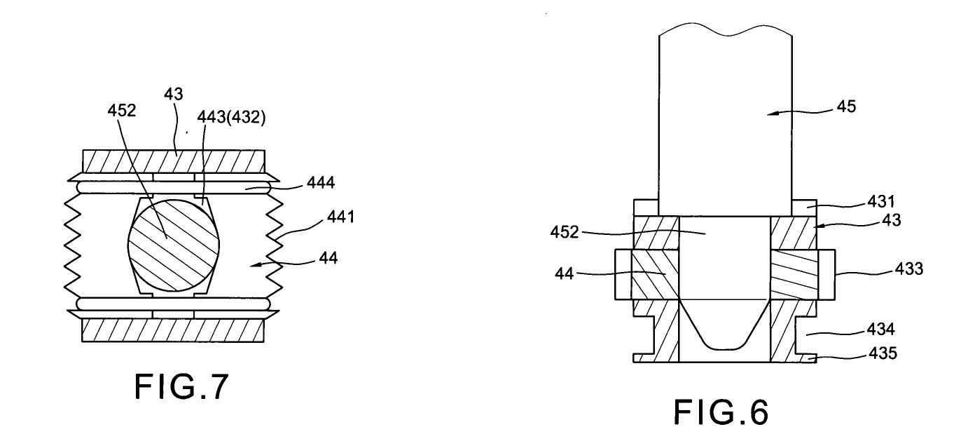

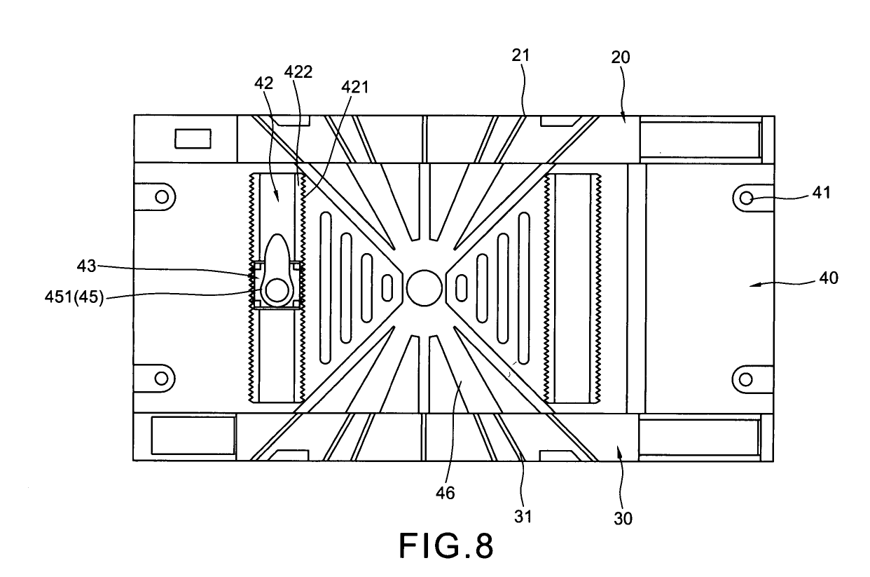

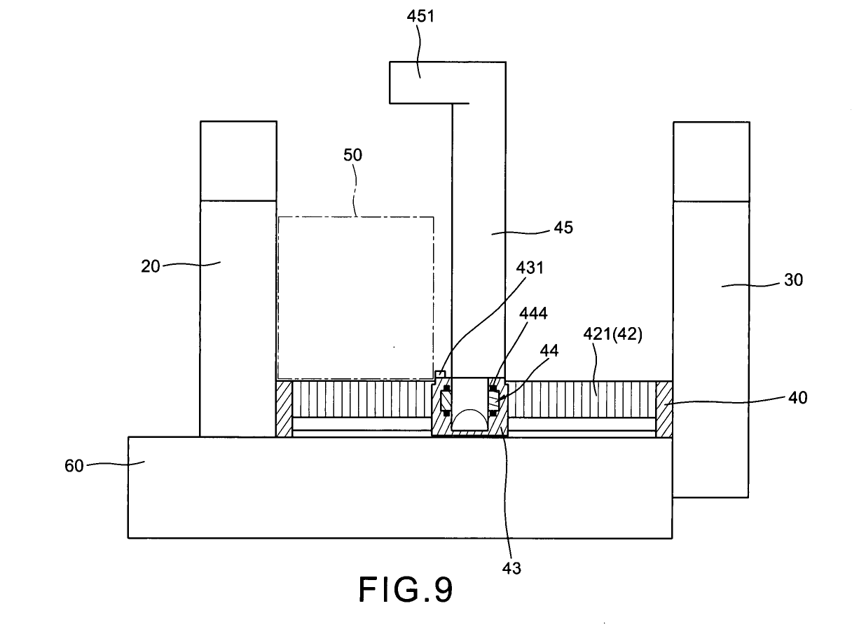

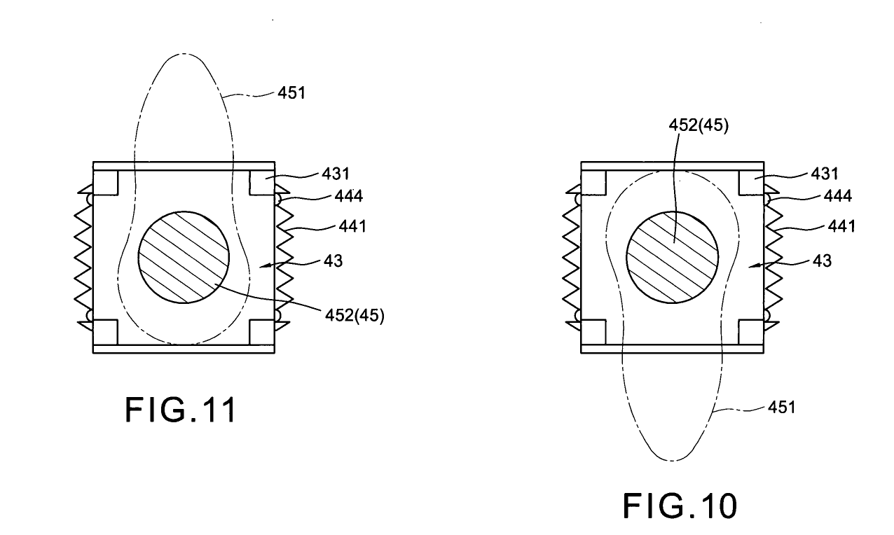

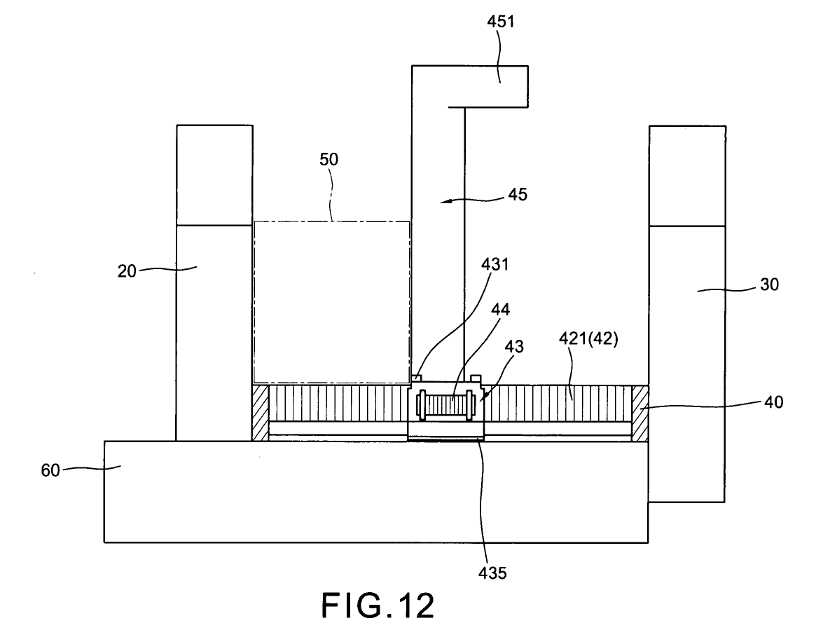

Referring to FIGS. 6, 7 and 8, due to the diameter of the protrusion 452 is larger then that of the expanding plates 44, the expanding plates 44 are expansible outward from the positioning plate 43 and its teeth engage with the rack 421 of the guide groove 42. So that the positioning plate 43 is immovable. If a piece of lumber 50 to be cut on the board 40, put it on the board and remove the positioning rod to permit the positioning plate 43 moving feely in the guide groove 42 until the lumber 50 is gripped between the positioning plate 43 and the rip fence 20, insert the positioning rod 45 into the positioning plate 43 again and rotate the handle 451 for about 180° toward the rip fence 30 such that the positioning plate is fixed as discussed in the above process (as shown FIGS. 9, 10 and 11). Since the lumber 50 is tightly gripped between the rip fence 20 and the positioning plate 43, a hacksaw 70 is adopted to cut the lumber 50 through a pair of the desired corresponding oblique vertical slots 21 and 31 (as shown in FIGS. 12 and 13).

The improved lumber positioning device of the present invention is characterized in the positioning plates 43 which is freely sliding in the guide grooves to accommodate the cutting lumber 50 to achieve a non-step positioning action. After the lumber is exactly gripped between the positioning plate 43 and the rip fence 20, rotate the positioning rod for about 180° to have the teeth of the symmetrical expanding plates 44 engaged with the rack of the guide groove 42, the positioning is being fixed without movement so that the lumber 50 is completely gripped for cutting with a hacksaw. No matter how large or how small is the size of the lumber 50. The non-step positioning arrangement omits the problems of selecting the exact positioning holes and/or repeatedly trying to accommodate the lumber 50 as did by the prior art lumber cutting bench which proves the novelty of the present invention.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

1. An improved lumber positioning device on a carpentry cutting bench comprising:
a rectangular board having a plurality of oblique cutting grooves radically formed in central surface, a pair of parallel transverse guide grooves beside said oblique cutting grooves, said guide grooves each having a rack on an inner wall and a protrudent bar on bottom, and four screw holes in horseshoe shaped grooves spacedly form at two ends for fixing said board on a table of a cutting bench by screws;
a pair of first and second rip fences respectively secured to lateral edges of said rectangular board by screws with the second rip fence slightly lower then bottom of said board for enabling a lower position of the second rip fence leaning on an edge of said table or engaged within a longitudinal groove of said table, said rip fences each having a plurality of oblique vertical slots corresponding with each other and respectively communicating with outer ends of said oblique cutting grooves;
a pair of positioning plates engaged on the protrudent bars within the guide grooves of said rectangular board and slidably secured by a pair of rectangular plates under said protrudent bars, said positioning plates having four projection on four upper corners, a vertical through hole in center, a pair of horizontal recesses in opposing lateral sides and a pair of indentations in opposing bottom edges;
a pair of symmetrical expanding plates respectively disposed within the horizontal recesses of said positioning plate and bound by a pair of elastic rings and each having a serrated outer edge engageable with the rack of said guide grooves and a semi-circular inner edge able to combined a circular hole engaged with the vertical through hole of said positioning plates;
a pair of positioning rods each having a lateral handle on top and an elliptic protrusion with an oblique distal portion eccentrically integrated with lower end engaged within the vertical through hole of said positioning plates and the circular hole of said symmetrical expanding plates;
whereby, slide said positioning plate freely toward a cutting lumber positioned on said board and leaned on a rip fence and rotate said positioning rod for 180° until said positioning plate tightly engaged with said cutting lumber so that said positioning plate is fixed and the cutting lumber is exactly gripped therebetween, then a hacksaw is adopted to cut the cutting lumber.

2. The improved lumber positioning device as recited in claim 1, wherein said symmetrical expanding plates is expanded outward and its serrated outer edge engages with the rack of said guide groove when said positioning rod is rotated.
